(19) United States
(12) Patent Application Publication
(10) Pub. No.: US 2013/0040032 A1
(43) Pub. Date: Feb. 14, 2013

(54) Horse Treats

(71) Applicant: Kyle Thibault, Goodyear, AZ (US)

(72) Inventor: Kyle Thibault, Goodyear, AZ (US)

(21) Appl. No.: 12/390,774

(22) Filed: Feb. 23, 2009

(51) Int. Cl. A23K 1/18; A23K 1/20; A23K 1/14

(52) U.S. Cl. 426/548; 426/512

(57) ABSTRACT

Horse treats sweetened with a sugar-free sweetener are disclosed. Compositions comprise Stevia as the sweetener. Methods of making these horse treats are described, as well.

### BACKGROUND

Horses are herbivores; feeding on plants. In the wild, other than the sugars found in the plants, sugar is not a natural part of a horse's diet. Certainly, wild horses do not encounter food sources in which the sweetness is artificially increased by adding refined or semi-refined sugar such as molasses or table sugar. On the other hand, domestic horses are exposed to sugar through sweet feeds and treats containing molasses, corn syrup and even given sugar cubes. Sugar is unhealthy for horses, but most horses like it. Because horses like sugar and because treats are used as rewards, they have enough refined or semi-refined sugar to artificially increase their sweetness. In the long term, this may be unhealthy for horses.

Fortunately, horses are living longer than ever before. But with longevity come age-related health problems and diseases. One such disease is Cushing's disease, which is similar to diabetes. Horses with Cushing's disease should not have sugar, not even the small amounts of sugar that carrots contain.

But owners and trainers of horses that have health problems such as Cushing's disease or laminitis, for example, face a big problem with what to reward horses with because normal horse treats cause high sugar levels in the horses' blood. Because many horses expect sugar in their treats they do not respond well to unsweetened treats. One solution is to give them a sweet, sugar-free treat. Even horse owners and trainers that have healthy horses want a healthy alternative to treats containing sugar.

There has been a long-term need for a healthy, sweet, sugar-free horse treat that does not contain refined or semi-refined sugar but that horses find palatable.

### SUMMARY

Compositions of some embodiments of the invention include horse treats sweetened with a sugar-free sweetener. In some embodiments, these compositions additionally contain or comprise grains and grasses, as well as materials derived from grains and grasses. In some embodiments, the sweetener is Stevia or a material contained within the Stevia plant.

Some of these compositions also contain flavored extracts.

In addition to compositions, methods of making, sugar-free sweetened treats are disclosed. In some embodiments, the treats are baked or extruded. In these or other embodiments, a batter is made before extrusion or baking.

### DETAILED DESCRIPTION

### Definitions

For purposes of this disclosure, the term “horse” includes any animal that is a member of the taxonomic family Equidae (sometimes known as the horse family) which includes horses and related animals, including the extant horses, donkeys, and zebras.

Palatable to a horse or other animal encompasses the behavior of the animal towards the foodstuff. In general, if an animal will accept the food into its mouth and voluntary swallow it, the food meets the definition of palatable for purposes of this document.

Sugar-free for purposes of this disclosure encompasses materials that do not contain refined or semi-refined sugar added primarily to increase the sweetness of the material. Definitions for refined sugars are well known to those of ordinary skill in the art and this document adopts those definitions. Semi-refined sugars are materials that have relatively high sugar levels, but have not been substantially purified or refined. Examples of these include beet or carrot pulp, molasses, sugar cane juice or syrup, maple syrup, corn syrup, etc.

Embodiments of this invention are horse treats or other animal treats made from any standard horse or animal treat formulation, but with any sweetening ingredient replaced by a sugar-free sweetener. In some embodiments, the sugar-free sweetener is Stevia, as described below.

In addition to containing a sugar-free sweetener, these horse treats can also contain flavorings that horses find palatable. In some embodiments of the current invention, horse treats contain flavorings selected from peppermint, gingerbread, banana, licorice, apple, cinnamon, mint, carrot, cherry and nutmeg, among other flavorings.

Horse treats are different from horse feed. Horse feed is given to horses to sustain them and a horse treat is given as a reward. Therefore, horse or equine foodstuffs are divided into feed and treats.

Horse feed can be minimally processed or processed. Minimally processed feed encompasses whole grains, cracked grains, rolled grains, etc. or whole or cut grasses. Processed feeds are grains, grasses, etc. that have been milled, chopped, ground, etc. and then pressed into pellets or otherwise stabilized as feed. Of course, those of ordinary skill in the art recognize that other feed processing can create processed feeds, as well.

Treats include sweetened or unsweetened treats. Of course, one of ordinary skill in the art recognizes that treats are marketed under a variety of terms including, among others, wafers, fortifiers, bars, edibles, cakes, snacks, treat, cookies, muffins, pastry, training aids, rewards, candy, supplements, nuggets, biscuits, crumbles, pops, nibbles, crunches, etc. The term treat encompasses any foodstuff that one of ordinary skill in the art recognizes as a treat regardless of what the foodstuff is called when it is marketed.

Unsweetened horse treats are horse treats with no added sweetener. In other words, no component is added to the treat mainly or predominantly for increasing the sweetness of the treat.

On the other hand, a sweetened horse treat contains a component that is added to the treat to increase the sweetness of the treat. This document calls such a component a sweetener. Sweeteners include sugars, artificial sweeteners such as sugar alcohols, saccharine, sucralose, aspartame, xylitol, etc., and sugar-free, natural sweeteners. While technically, sugar alcohols occur naturally in certain plants and plant extracts, most used for food consumption appear to be produced artificially.

Most of the horse treats available today contain refined and semi refined sugar. Since the safety of artificial sweeteners have been in question and seem to pose a health risk, another sweetener had to be found.

### Feed Versus Treat

Horse feeds (as other animal feeds) make up as much as 90 to 100% of the horses caloric intake, in some cases, as much as 99 to 100% of the horses intake. The feed typically can be a mixture of grains, grasses and plants.

Treats contain sweeteners or other components to increase their palatability to the horse. These additives make the horses enjoy the treat more than normal feed. Hence, the trainer can use the treat to entice the horse to behave in a way that the horse may not otherwise be inclined to.

One aspect of a horse treat is that it is not intended to provide a substantial portion of the horse's daily intake. In some cases, treats supply less than 25, 15, 10, 5, 2, 1, or 0.5% of the horse's daily caloric needs. Among other characteristics known to those of ordinary skill in the art, adapted for consumption by a horse means that the composition has some of the characteristics discussed above.

### Treat Formulation

As discussed above, treats have ingredients to increase their palatability over feeds. These ingredients should be incorporated into the treat or onto the treat to give it a consistency that the horse finds palatable and a shape or configuration that makes it convenient for treating the horse with individual treats or with small numbers of treats.

One way of transforming the ingredients into the correct shape or consistency is to create a batter by adding liquid (such as water) or other binder to the ingredients. This batter is then cut to the correct shape and baked. In some embodiments, the batter is extruded and then cut into the correct shape and baked. In other embodiments, the batter is extruded such that no baking is needed. In other embodiments the batter is extruded in such a way that baking occurs as the batter exits the extrusion die.

Another way of transforming the ingredients into the desired shape and consistency is to add a gelling agent and then place the mixture into sheets or molds and allow the mixture to gel. In some embodiments, the gel is allowed to dry or is heated to dry. In some embodiments, the sheets are cut to shape before drying. In other embodiments the sheets are cut to shape after drying.

Another way the ingredients can be transformed is by compressing them in a press either with or without first making a batter of the ingredients.

Those of ordinary skill in the art recognize that other ways of making these transformations of individual ingredients into horse treats exist. This document encompasses all such known methods.

Alternatively, a horse treat can be made, either with or without sugar or artificial sweetener, and to this treat, Stevia can be added. For instance, a solution or powder containing Stevia can be applied to a horse treat.

### Stevia

For purposes of document, the term Stevia encompasses any composition containing one or more compounds that give plants from the genius Stevia their sweet taste including the plant or portions of the plant itself, extracts of the plant, and the compounds discussed below either by function, name, or structure. This plant genus contains more than 200 species of plants native to South America, Central America, Mexico, Arizona, New Mexico, and Texas. The leaves of the Stevia plant have 3045 times the sweetness of sucrose (ordinary table sugar). The plant's leaves, the aqueous extract of the leaves, and purified steviosides are used as sweeteners. Two compounds that give Stevia plants their sweet taste are named stevioside and rebaudioside, and are 250-300 times sweeter than sucrose. Truvia product and PureVia are RebA stevia extracts that are generally recognized as safe by the FDA and are both derived wholly from the Stevia plant. Moreover, compounds that give these plants there sweet taste comprise a derivative of Steviol, which is shown below. For purposes of this document, a compound that is a derivative of Steviol and having the capability to sweeten a composition falls within the term Stevia.

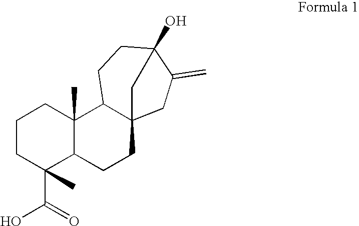

Of course, those of ordinary skill in the art recognize that Stevia can be combined with other natural and artificial sweeteners. Such combinations fall within the scope of the claims that appear after this description.

### Experimental

### Tests

The table set out below list three tests: a smell test, a first-day consumption test, and a second-day consumption test. These are labeled “smell”, “first day”, and “second day” respectively, in the table. These tests were conducted for each formulation on 23 horses. The table shows the pass rate for the formulation. For instance, an entry of “several horses” means that the formulation passed the test for several horses.

The smell test involves offering the treat to the horse. The horse will smell the treat and, if it likes the smell, it accepts the treat into its mouth. If a horse accepts the treat, the smell test is considered passed for that horse.

The first-day consumption test is the first taste test. A pass for a horse on this test would occur if the horse ate the treat, showed cues that it wanted another treat, and ate the second treat. Cues that the horse wants another treat include nudging, sniffing, or licking the trainer's hand.

The second-day consumption test is much like the first. The difference is that the treat is offered on the day following the first-day test.

### Treat Formulations

The first test was conducted with a treat that contained no sugar. Thus, it is classified as a sugar-free treat. This formulation appears in the table as “standard”. The second test used treats that contained flavors prepared with vanilla, anise, and almond cooking extracts, and appear as such in the table. The difference between these flavored treats and the treat from the first test was only the addition of the identified extract.

The Stevia treat was prepared by adding Stevia to the treat from the first test. No other changes were made. It appears in the table as “Stevia”.

| Formulation | Smell Test | First-day | Second-day |
|---|---|---|---|
| Standard | Several horses | No horses | — |
| Vanilla | Most horses | No horses | — |
| Anise | Most horses | No horses | — |
| Almond | Most horses | No horses | — |
| Stevia | All horses | All horses | All horses |

As can be seen from the table, the treat from the first test was rejected by most horses in all three tests. The flavored treat formulations fared well with the smell test, but when the horses tasted them, they spit them out. The treat sweetened with Stevia was a success. It passed the second-day consumption test in all 23 horses.

1-20. (canceled)

21. A horse treat consisting of:
a material comprising one of grain, grass, processed grain, processed grass, and any combination thereof;
only one sugar-free sweetener; and
a liquid or binder;
wherein a shape of the horse treat is selected from the group consisting of wafers, bars, cakes, cookies, muffins, pastries, candies, nuggets, biscuits, pops, and pie;
wherein the horse treat has a palatability level to the horse greater than that of a horse food selected from the group consisting of grains, grasses, plants, and any combination thereof.

22. The horse treat of claim 21, wherein the sugar-free sweetener is Stevia, and the Stevia is selected from the group consisting of the whole Stevia plant, Stevia leaves, Stevia stems, Stevia roots, extracts from the whole Stevia plant, extracts from Stevia leaves, extracts from Stevia stems, extracts from Stevia roots, stevioside, rebaudioside, a derivative of steviol, and any combination thereof.

2-25. (canceled)

26. A horse treat consisting essentially of:
a material comprising one of grain, grass, processed grain, processed grass, and any combination thereof;
a liquid or binder; and
Stevia ;
wherein the horse treat has a palatability level to the horse greater than that of a horse food selected from the group consisting of grains, grasses, plants, and any combination thereof; and
wherein the Stevia permits the horse treat to be consumed by horses having Cushing's disease and laminitis.

27. The horse treat of claim 26, further comprising wherein because the horse treat has a palatability level to the horse greater than that of horse food, the horse treat is configured to allow a user to entice a horse to behave in a way that a horse may not otherwise be inclined.

28. (canceled)

29. The horse treat of claim 26 wherein the Stevia is selected from the group consisting of the whole Stevia plant, Stevia leaves, Stevia stems, Stevia roots, extracts from the whole Stevia plant, extracts from Stevia leaves, extracts from Stevia stems, extracts from Stevia roots, stevioside, rebaudioside, a derivative of steviol, and any combination thereof

30. The horse treat of claim 26, wherein the horse treat is configured to provide less than about 20, about 10, about 5, or about 1 percent of the horse's daily caloric requirement.

31. The horse treat of claim 26, further comprising a flavoring selected from the group consisting of peppermint, gingerbread, banana, licorice, apple, cinnamon, mint, carrot, cherry, nutmeg, and any combination thereof

32. A method of forming the horse treat of claim 26, the method comprising:
providing one of grain, grass, processed grain, processed grass, and any combination thereof;
mixing Stevia with the one of grain, grass, processed grain, processed grass, and any combination thereof;
adding the liquid or binder to form a batter;
shaping the batter into a portion; and
drying the portion to remove excess moisture to form a horse treat as a solid object.

33. The method of claim 32 wherein drying the portion further comprises baking, processing in a baking-extruding device, or processing in a dryer.

34. The method of claim 32 wherein drying the portion further includes room temperature drying.

35. The method of claim 32 wherein drying the portion to remove excess moisture to form the horse treat further comprises creating a texture of the horse treat that is palatable to the horse.

36. The method of claim 32 wherein mixing Stevia further comprises mixing Stevia selected from the group consisting of the whole Stevia plant, Stevia leaves, Stevia stems, Stevia roots, extracts from the whole Stevia plant, extracts from Stevia leaves, extracts from Stevia stems, extracts from Stevia roots, stevioside, rebaudioside, a derivative of steviol, and any combination thereof

37. A method of altering the behavior of a horse, the method comprising:
providing a horse treat comprising a sugar-free sweetener, and one of grain, grass, processed grain, processed grass, and any combination thereof, the horse treat having a palatability level to the horse greater than that of a horse feed; and
enticing the horse using the horse treat to behave in a way that the horse may not otherwise be inclined to.

38. The method of claim 37 wherein providing a horse treat comprising a sugar-free sweetener further comprises wherein the sugar-free sweetener is Stevia selected from the group consisting of the whole Stevia plant, Stevia leaves, Stevia stems, Stevia roots, extracts from the whole Stevia plant, extracts from Stevia leaves, extracts from Stevia stems, extracts from Stevia roots, stevioside, rebaudioside, steviol, and any combination thereof

39. The method of claim 37 further comprising feeding one or more horse treats to the horse, wherein the total daily caloric value of the horse treats consumed by the horse is less than about 20, about 10, about 5, or about 1 percent of the horse's daily caloric requirement.

40. The method of claim 37 wherein providing a horse treat further comprises wherein the horse treat is a solid object with a shape or configuration adapted to allow a user to administer the treat to a horse with one hand.
